(19) United States
(12) Patent Application Publication
(10) Pub. No.: US 2025/0033366 A1
(43) Pub. Date: Jan. 30, 2025

(54) PRINTING APPARATUS

(71) Applicant: CANON KABUSHIKI KAISHA, Tokyo (JP)

(72) Inventors: HIDEAKI MATSUMURA, Tokyo (JP); YUSUKE NARATANI, Tokyo (JP); ERIKA IYAMA, Kanagawa (JP); TAIJI MARUYAMA, Kanagawa (JP); HIROMASA TSUTSUMI, Kanagawa (JP); TSUYOSHI SAEKI, Kanagawa (JP); SHOTA ASADA, Tokyo (JP); NORIO SAKURAI, Tokyo (JP); NOBUHIRO TOKI, Kanagawa (JP)

(21) Appl. No.: 18/778,962

(22) Filed: Jul. 20, 2024

(30) Foreign Application Priority Data
Jul. 27, 2023 (JP) 2023-122180

(51) Int. Cl. B41J 2/175

(52) U.S. Cl. CPC B41J 2/17523; B41J 2/17513; B41J 2/1753; B41J 2/17553; B41J 2/17556; B41J 2/17566

(57) ABSTRACT

A conveyance unit configured to convey a print medium in a first direction; a printing unit configured to perform printing by ejecting ink onto the print medium conveyed by the conveyance unit; a first tank configured to store ink to be supplied to the printing unit; and a second tank configured to be installed side by side with the first tank in a second direction intersecting the first direction, and to be formed so that a storage chamber that stores ink to be supplied to the printing unit overlaps with the first tank as viewed from the first direction are included, and the storage chamber overlaps with the first tank as viewed from a third direction intersecting the first direction and the second direction.

### BACKGROUND OF THE INVENTION

### Field of the Invention

The present invention relates to a printing apparatus equipped with a tank for storing a liquid such as ink.

### Description of the Related Art

Ink tanks that store ink to be supplied to a print head that ejects ink are installed in inkjet printing apparatuses. In inkjet printing apparatus capable of printing in color, ink tanks that are independent of one another for each of usable ink colors are installed side by side in the width direction.

Japanese Patent Laid-Open No. 2018-069696 discloses a technology in which the width of a specific ink tank is widened compared to other ink tanks among multiple ink tanks in order to increase the amount of ink that can be stored in that specific ink tank.

The minimum width of an ink tank is decided according to the length of the injection port for injecting ink in the width direction. Therefore, in a case where the width of the other ink tanks is the minimum width and it is desired to increase the storage capacity of a specific ink tank and widen the width thereof for that purpose, the width of the other ink tanks cannot be narrowed by the amount the width of the specific ink tank was widened. Therefore, in an inkjet printing apparatus, a large space is required to accommodate these ink tanks, which may result in an increase in the size of the apparatus.

### SUMMARY OF THE INVENTION

The present invention was made in view of the above issues, and provides a technology capable of suppressing the expansion of the space where the tanks that store the printing agents are accommodated.

A printing apparatus includes: a conveyance unit configured to convey a print medium in a first direction; a printing unit configured to perform printing by ejecting ink onto the print medium conveyed by the conveyance unit; a first tank configured to store ink to be supplied to the printing unit; and a second tank configured to be installed side by side with the first tank in a second direction intersecting the first direction, and to be formed so that a storage chamber that stores ink to be supplied to the printing unit overlaps with the first tank as viewed from the first direction, wherein the storage chamber overlaps with the first tank as viewed from a third direction intersecting the first direction and the second direction.

According to the present invention, it is possible to suppress the expansion of the space where the tanks that store the printing agents are accommodated.

Further features of the present invention will become apparent from the following description of exemplary embodiments with reference to the attached drawings.

### BRIEF DESCRIPTION OF THE DRAWINGS

FIG. 1 is a schematic configuration diagram of the printing apparatus;

FIG. 2 is a block configuration diagram of the control portion;

FIG. 3A and FIG. 3B are perspective views of the ink tank unit;

FIG. 4A and FIG. 4B are schematic configuration diagrams of the particular ink tank;

FIG. 5A and FIG. 5B are schematic configuration diagrams of another ink tank;

FIG. 6A and FIG. 6B are diagrams of the configuration of the vicinity of the detection pins in an ink tank;

FIG. 7 is a side view of the particular ink tank;

FIG. 8 is a cross-sectional view of the VIII-VIII line of FIG. 3A;

FIG. 9 is an enlarged view of the vicinity of the fixing portion in FIG. 8;

FIG. 10A and FIG. 10B are diagrams illustrating a modification example of the printing apparatus and the ink tank unit;

FIG. 11A to FIG. 11C are diagrams illustrating a modification example of the printing apparatus and the ink tank unit;

FIG. 12 is a diagram illustrating a modification example of the fixing portion; and

FIG. 13A and FIG. 13B are cross-sectional views of the ink tanks illustrated in FIG. 12.

### DESCRIPTION OF THE EMBODIMENTS

Hereinafter, with reference to the accompanying drawings, a detailed explanation is given of an example of embodiments of a printing apparatus. Note that the following embodiments are not intended to limit the present invention, and every combination of the characteristics explained in the present embodiments is not necessarily essential to the solution provided in the present invention. Further, the positions, shapes, etc., of the constituent elements described in the embodiments are merely examples and are not intended to limit the range of this invention to the examples.

### (Configuration of the Printing Apparatus)

The printing apparatus according to the present embodiment may be an apparatus equipped only with the function of printing an image by ejecting ink onto a print medium, or the printing apparatus may be a multifunction peripheral equipped with the function of reading images and the like. In the present embodiment, an explanation is given as an example of a printing apparatus capable of color printing by ejecting ink of multiple colors. Therefore, in the present embodiment, as an example of the tanks, an explanation is given of ink tanks that store ink as liquid.

Note that, in the present embodiment, the liquid that can be stored in the tanks (hereinafter also referred to as the “liquid storage tanks”) is not limited to ink, which serves as a printing agent, but includes the various known printing agents used for printing, such as a treatment liquid that performs a specified treatment on the ejected ink. Alternatively, the various liquids used in a variety of known apparatuses that eject liquids to obtain a desired end product are included.

In the present specification, while facing the side from which the print medium is discharged after printing, the direction going from the left side towards the right side of the apparatus is explained as the X direction, the direction going from the rear side (the back side) towards the near side (the front side) is explained as the Y direction, and the direction going from the lower side towards the upper side is explained as the Z direction. In this way, the X, Y, and Z directions are directions going from one side to the other side, and are directions orthogonal to one other. In the present specification, each direction is represented with a “+ (plus)” in a case of going from the one side to the other side, and with a “− (minus)” in a case of going from the other side to the one side, as appropriate.

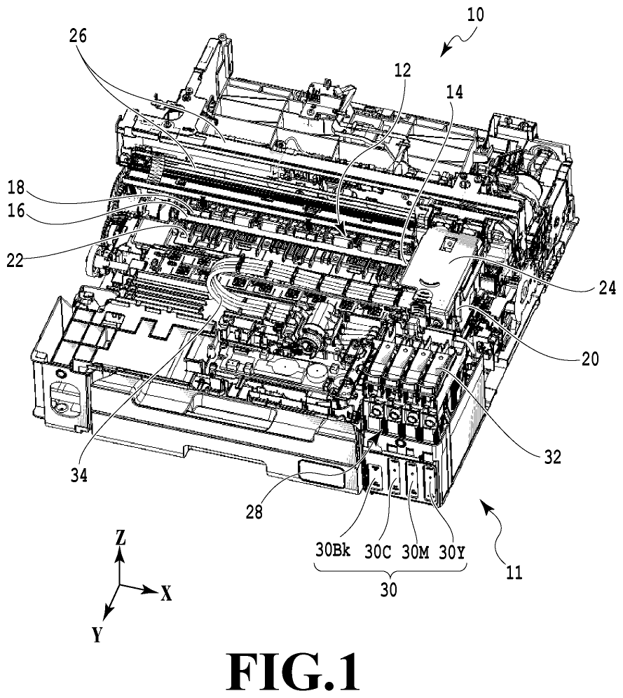

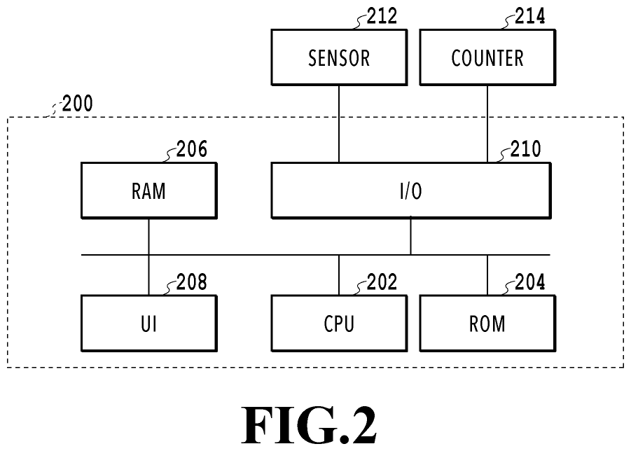

FIG. 1 is a schematic configuration diagram of the printing apparatus equipped with the liquid storage tanks according to the present embodiment. The printing apparatus 10 is equipped with the conveyance portion 12 that conveys the print medium fed from a feeding portion not illustrated in the drawings in the Y direction, and the printing portion 14 that ejects ink and performs printing onto the print medium conveyed by the conveyance portion 12. Note that the print medium on which printing has been performed by the printing portion 14 is discharged outside the apparatus at the front of the apparatus by a discharging portion (not illustrated in the drawings). Further, the printing apparatus 10 is also equipped with the accommodation portion 11 that accommodates the tanks (described later) that store the inks used in printing by the printing portion 14. Furthermore, the printing apparatus 10 is equipped with the control portion 200 (see FIG. 2) that controls the overall operation.

The conveyance portion 12 is equipped with the conveyance roller 16, which is driven by a driving portion (not illustrated in the drawings), and the pinch roller 18 that makes pressure contact with the conveyance roller 16 and is associatively driven by the conveyance roller 16. The print medium fed by the feeding portion is nipped by the conveyance roller 16 and the pinch roller 18, and conveyed to the printing portion 14 by the rotation of the conveyance roller 16. The conveyance roller 16 is a metal roller that has been processed to have fine asperities on the surface with which the pinch roller 18 makes pressure contact, so that a frictional force is generated between the print medium and the roller as the roller nips the print medium with the pinch roller 18. The pinch roller 18 is elastically biased against the conveyance roller 16 by a biasing member such as a spring.

The printing portion 14 is equipped with the print head 20 that ejects ink and performs printing onto the print medium conveyed by the conveyance portion 12, and the platen 22 that supports the print medium being conveyed in the print area where ink is ejected onto the print medium by the print head 20. This platen 22 is arranged so as to face the ejection port surface where the ejection ports that eject ink are formed in the print head 20, and thereby the print medium supported by the platen 22 is maintained at a predetermined distance from the ejection port surface of the print head 20. The print medium on which printing has been performed by the printing portion 14 is conveyed to the discharging portion and discharged from the front of the printing apparatus 10 to the outside of the apparatus by the discharging portion. In the discharging portion, for example, after printing, the print medium is discharged by being nipped between the discharge roller and a spur. The discharge roller is, for example, a rubber roller with a large coefficient of friction, and the spur is, for example, elastically biased against the discharge roller by a biasing unit such as a spring.

The print head 20 is mounted on the carriage 24, which can reciprocally move in the X direction, facing the surface of the print medium supported by the platen 22. Accordingly, the print head 20 is configured to be reciprocally movable in the X direction via the carriage 24. The carriage 24 is installed with the ability to slide on a pair of guide rails 26 extending in the X direction. The print head 20 is mounted on the carriage 24 in a removable manner. Further, the print head 20 is configured to be able to eject ink using an inkjet system. The print head 20 is equipped with a configuration that generates thermal energy, such as, for example, a heating element, as the energy utilized to eject ink. Note that the inkjet system applied to the print head 20 is not limited to a method using a heating element, and various known methods such as a method using a piezoelectric element may be used.

In the print head 20, multiple ejection ports for ejecting ink are arranged in arrays on the ejection port surface facing the platen 22 to form ejection port arrays. The ejection port arrays extend in a direction intersecting the movement direction of the print head 20, for example, along the Y direction. The print head 20 is configured to be able to eject four colors of ink that are different from each other. Accordingly, ejection port arrays are formed for each color on the ejection port surface of the print head 20.

In the present embodiment, the print head 20 is configured to be able to eject four colors of ink including black (Bk) ink, cyan (C) ink, magenta (M) ink, and yellow (Y) ink. Note that the inks that can be ejected from the print head 20 are not limited to the four colors described above. In other words, the ink that can be ejected from the print head 20 may be a different color than the colors described above, or the number of colors may be fewer or more colors than the four colors described above.

The print head 20 is connected to the ink tank unit 28 (described later), which is accommodated in the accommodation portion 11 and stores each ink independently, and is configured to be able to eject ink supplied from the ink tank unit 28 from the ejection ports. The ink tank unit 28 is connected to the print head 20 via the tubes 34 for each type of ink. Furthermore, the printing apparatus 10 is configured so that ink stored in the ink tank unit 28 can be supplied to the print head 20 independently for each type of ink.

During printing in the printing apparatus 10 equipped with the printing portion 14 as such, the print medium is first conveyed to the printing start position by the conveyance portion 12. Next, a printing operation is performed on the print medium conveyed to the printing start position, in which the print head 20 ejects ink while moving in the X direction. Thereafter, the conveyance portion 12 performs a conveyance operation to convey the print medium only by a predetermined amount, and subsequently, the printing operation is performed again. In this way, the printing apparatus 10 performs the predetermined printing on the print medium by alternately and repeatedly executing the conveyance operation and the printing operation.

The accommodation portion 11 accommodates the ink tank unit 28 that stores ink to be supplied to the print head 20 independently for each type of ink. In the present embodiment, the accommodation portion 11 is positioned on the front right side of the printing apparatus 10, i.e., on the front side of the print head 20 in the stand-by position. Note that the stand-by position is the position where the print head 20 is positioned while printing is not performed, as illustrated in FIG. 1.

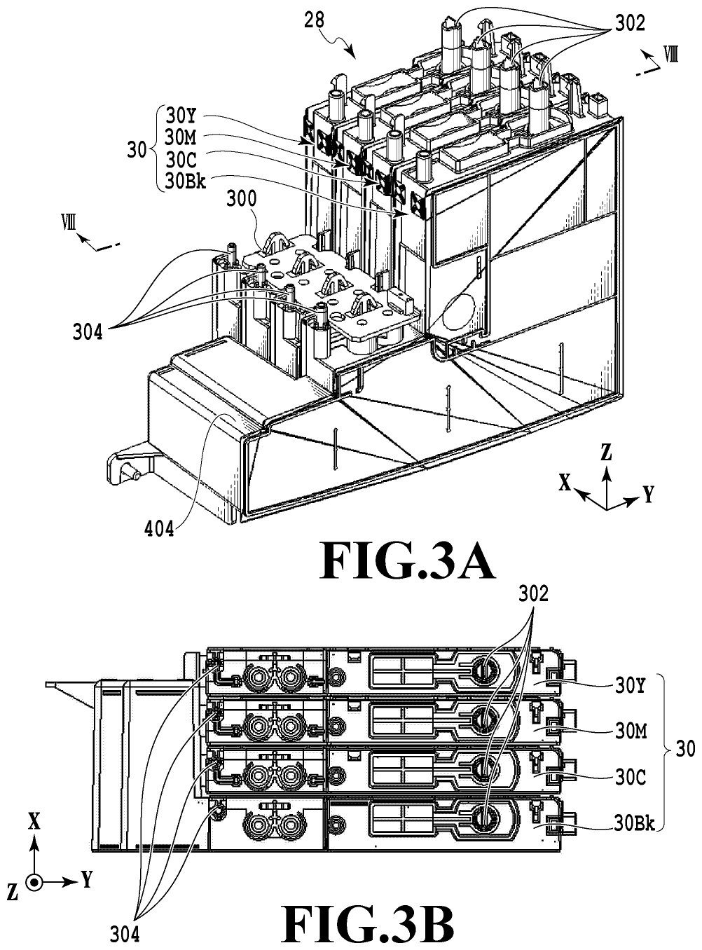

In the present embodiment, the ink tank unit 28 is equipped with the ink tank 30Bk for storing Bk ink, the ink tank 30C for storing C ink, the ink tank 30M for storing M ink, and the ink tank 30Y for storing Y ink. In the present embodiment, the ink tank 30C, the ink tank 30M, and the ink tank 30Y have the same configuration. At the top of each of the ink tanks 30, the injection port 302 (see FIG. 3A) for injecting the corresponding ink into the ink tank, and the plug member 32 that can be opened and closed to cover the injection port 302 or expose the injection port 302 to the outside are installed. Note that the detailed configuration of each of the ink tanks 30 is described later.

Further, although not illustrated in the drawings, the printing apparatus 10 is equipped with a recovery unit for performing a recovery operation to maintain and recover good ink ejection performance in the print head 20. The recovery unit is arranged at a position opposite the ejection port surface of the print head 20 positioned in the stand-by position. The recovery unit is equipped with, for example, a cap portion for capping and protecting the ejection port surface of the print head 20, a suction portion for forcibly sucking ink from the print head 20 with the ejection port surface in a capped state, and a wiper portion for wiping the ejection port surface.

### (Configuration of the Control Portion)

Next, an explanation is given about the configuration of the control portion that controls the entire printing apparatus 10. FIG. 2 is a block diagram illustrating the configuration of the control portion. The control portion 200, which controls the overall operation in the printing apparatus 10, is equipped with the central processing unit (CPU) 202 that controls the operation of each component in the printing apparatus 10, performs processing on input image data, etc., based on various programs. Further, the control portion 200 is equipped with the ROM 204 that stores various control and image data processing programs executed by the CPU 202, and the RAM 206 that is used as a storage area to save a variety of data used to control the printing apparatus 10 and as a work area.

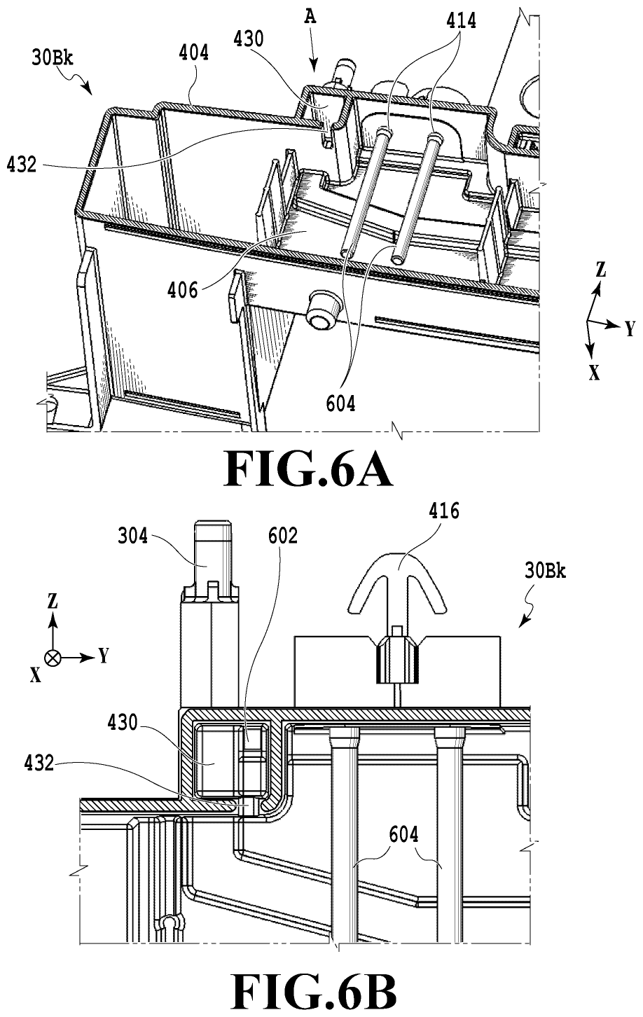

Furthermore, the control portion 200 is equipped with the user interface (UI) 208, which includes keys that the user operates and a display panel that displays various information, and the input/output interface circuit (I/O) 210 for various externally connected devices. To the control portion 200, the sensor 212 installed in the printing apparatus 10 is connected via the I/O 210. Note that, in FIG. 2, for ease of understanding, various detection portions installed in the printing apparatus 10 are collectively represented by the sensor 212. This sensor 212 includes, for example, the detection pins 604 (see FIG. 6A), which can detect if the remaining amount of ink stored in the ink tanks 30 has become a predetermined amount or less, and the like.

Note that, although the details are described later, in the ink tanks 30, the substrate 300 (see FIG. 3A) is attached to connect the detection pins 604, a power supply (not illustrated in the drawings), and the control portion 200. Thus, voltage is applied to the detection pins 604 from the power supply via the substrate 300, and the detection result of the detection pins 604 is output to the control portion 200 via the substrate 300. Then, based on the detection result, the control portion 200 detects if the remaining amount of the ink has become a predetermined amount or less. Further, the control portion 200 is equipped with the counter 214 that counts the number of times ink is ejected from the print head 20 via the I/O 210. The counter 214 counts the number of ejections for each type of ink. The control portion 200 calculates the consumption of ink, at a timing such as the end of an operation to eject ink, by multiplying the count value of the counter 214 by the ejection volume of ink used in one cycle. Note that the ejection volume of ink used in one cycle is held in advance in a storage area such as the RAM 206. Furthermore, the control portion 200 writes information about the remaining amounts of ink inside the ink tanks 30. The control portion 200 manages the remaining amounts of ink inside the ink tanks 30 by, for example, calculating the consumption of ink from the point in time where the remaining amount of ink became the predetermined amount or less based on the detection result of the detection pins 604.

### (Configurations of the Ink Tanks)

Next, an explanation is given about the configurations of the ink tank unit 28 and the ink tanks 30. Note that, regarding the ink tanks 30, the ink tank 30C, the ink tank 30M, and the ink tank 30Y have the same configuration as each other, while the configuration of the ink tank 30Bk differs from that of the other three ink tanks. For this reason, in the explanation of the configurations of the ink tanks 30, an explanation is given of the configuration of the ink tank 30Bk and the configuration of the ink tank 30C, and an explanation of the configuration of the ink tank 30M and the ink tank 30Y is omitted.

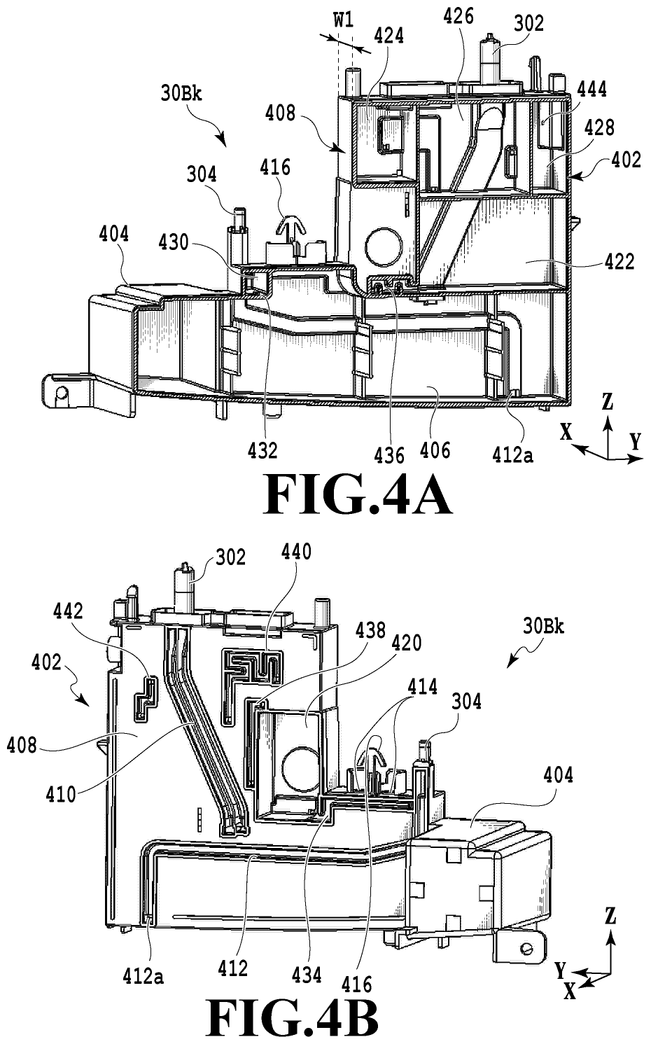

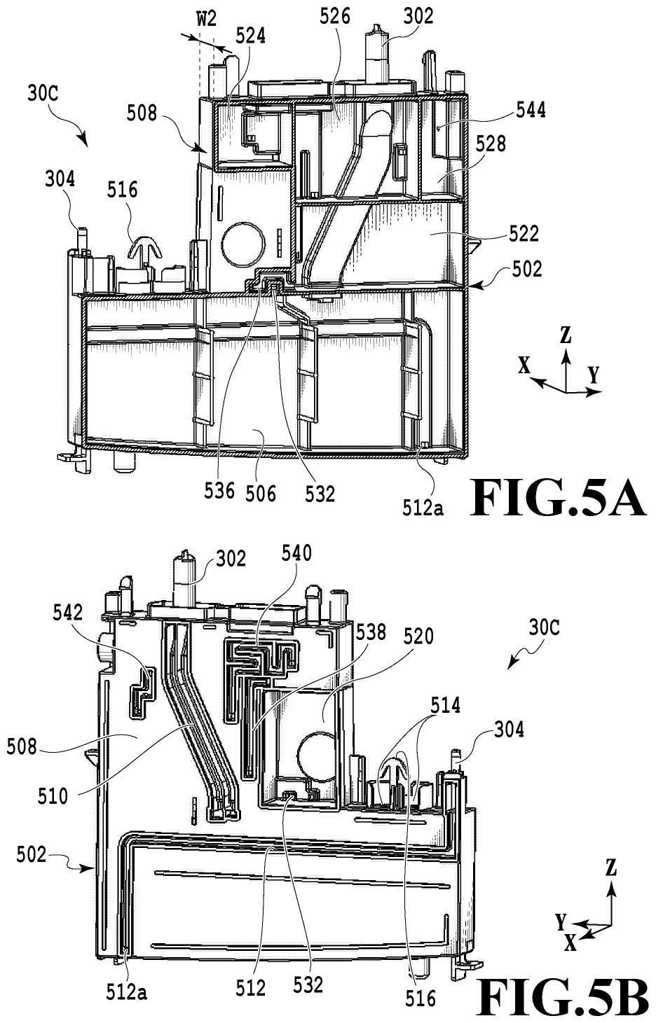

FIG. 3A and FIG. 3B are schematic configuration diagrams of the ink tank unit 28. FIG. 3A is a perspective view, and FIG. 3B is a plan view. Note that the substrate 300 is in an attached state in FIG. 3A, whereas the substrate 300 is in a detached state in FIG. 3B. FIG. 4A and FIG. 4B are schematic configuration diagrams of the ink tank 30Bk. FIG. 5A and FIG. 5B are schematic configuration diagrams of the ink tank 30C. Note that in FIG. 3A to FIG. 5B, for ease of understanding, the illustration of the plug member 32 is omitted. Further, in the explanation of the ink tank unit 28 and the ink tanks 30 using the drawings from FIG. 3A and FIG. 3B onward, for ease of understanding, the explanation is given with the directions at the time of being accommodated in the accommodation portion 11 of the printing apparatus 10.

### <Schematics of the Ink Tank Unit 28>

In the ink tank unit 28, the ink tank 30C, the ink tank 30M, and the ink tank 30Y, which have the same configuration as each other, and the ink tank 30Bk, which has a larger capacity than the ink tank 30C and the others, are installed side by side along the X direction (see FIG. 3B). In the ink tank unit 28, the substrate 300 is fixed to each of the ink tanks 30 (see FIG. 3A). In the ink tank unit 28, the injection ports 302 formed at the tops of the respective ink tanks 30 are designed to be arranged at equal intervals. In the ink tank unit 28, the ink tanks 30 are connected to the tubes 34 at the joint portions 304, respectively.

### <Configuration of the Ink Tank 30Bk>

The ink tank 30Bk, which has a larger capacity than the ink tank 30C, etc., is equipped with the main body portion 402 formed with the width W1 in the X direction and the enlarged portion 404 extending in the X direction on one side of the main body portion 402 in the Y direction, that is, on the back side (see FIG. 4A). Note that, in the ink tank unit 28, the ink tank 30Bk, the ink tank 30C, the ink tank 30M, and the ink tank 30Y are arranged in this order in the +X direction. Therefore, in the present embodiment, the enlarged portion 404 in ink tank 30Bk extends in the +X direction where the other ink tanks 30C, 30M, and 30Y are positioned. The main body portion 402 is equipped with the storage chamber 406 that communicates with the enlarged portion 404 and stores ink together with the enlarged portion 404. Note that the enlarged portion 404, together with the storage chamber 406 in the ink tank 30Bk, is configured to store ink, and the installation of this enlarged portion 404 allows the ink tank 30Bk to store more ink than the other ink tanks.

The main body portion 402 is equipped with the buffer portion 408 formed on the upper front side of the storage chamber 406 that serves as an atmospheric communication flow path for the storage chamber 406, and the inlet path 410 that allows ink injected from the injection port 302 to flow into the storage chamber 406 (see FIG. 4B). Further, the main body portion 402 is equipped with the connecting path 412 that connects the storage chamber 406 to the joint portion 304. The opening portion 412a is formed at one end of the connecting path 412, which extends to near the bottom surface of the storage chamber 406, whereas the other end of the connecting path 412 is connected to the joint portion 304. The ink stored in the storage chamber 406 is transferred from the opening portion 412a to the joint portion 304 via the connecting path 412. The opening portion 412a is positioned on the front side of the storage chamber 406, and the bottom surface of the storage chamber 406 is shaped to slope gently downward from the back side to the front side. Further, the main body portion 402 is equipped with the insertion portions 414 through which the detection pins 604 can be inserted on the upper back side of the storage chamber 406, and the fixing member 416 that can fix the substrate 300.

The buffer portion 408 is equipped with five buffer chambers. Specifically, the buffer portion 408 is equipped with the first buffer chamber 420 positioned on the lower back side of the buffer portion 408, the second buffer chamber 422 positioned on the lower front side of the buffer portion 408, and the third buffer chamber 424 positioned on the upper side of the first buffer chamber 420. Further, the buffer portion 408 is equipped with the fourth buffer chamber 426 positioned on the upper back side of the second buffer chamber 422, and the fifth buffer chamber 428 positioned on the upper front side of the second buffer chamber 422.

The storage chamber 406 is connected to the first buffer chamber 420 via the small chamber 430. The small chamber 430 is positioned on the upper back side of the storage chamber 406 and behind the insertion portion 414 and in front of the enlarged portion 404 in the Y direction. The opening 432 is formed on the bottom surface of the small chamber 430, and the small chamber 430 and the storage chamber 406 communicate via this opening 432. Further, the small chamber 430 communicates with the first buffer chamber 420 via the flow path 434, and the first buffer chamber 420 communicates with the second buffer chamber 422 via the flow path 436. Furthermore, the second buffer chamber 422 communicates with the third buffer chamber 424 via the flow path 438, and the third buffer chamber 424 communicates with the fourth buffer chamber 426 via the flow path 440. Moreover, the fourth buffer chamber 426 communicates with the fifth buffer chamber 428 via the flow path 442, and the fifth buffer chamber 428 communicates with the outside of the ink tank 30Bk via the atmospheric communication port 444.

In this way, the storage chamber 406 is configured to communicate with the outside via the small chamber 430, the first buffer chamber 420, the second buffer chamber 422, the third buffer chamber 424, the fourth buffer chamber 426, and the fifth buffer chamber 428. Further, the first buffer chamber 420 opens in the +X direction, and the flow path 436 is configured to open in a different direction than the first buffer chamber 420 (that is, in the −X direction). Similarly, the second buffer chamber 422, the third buffer chamber 424, and the fourth buffer chamber 426 open in the −X direction, and the flow path 438, the flow path 440, and the flow path 442 open in the +X direction. Because the buffer chambers and the flow paths that communicate with the buffer chambers open in different directions, the configuration is such that it is difficult for the ink stored in the storage chamber 406 to leak out to the outside via the atmospheric communication port 444, no matter what the posture of the ink tank 30Bk is. Note that, on the side surface of the left side of the ink tank 30Bk, a film (not illustrated in the drawings) is welded to the main body portion 402 and the enlarged portion 404, and on the side surface of the right side, another film (not illustrated in the drawings) is welded to the main body portion 402. This seals the storage chamber 406, each buffer chamber in the buffer portion 408, the inlet path 410, the connecting path 412, and the flow paths communicating with each buffer chamber. The right side surface of the enlarged portion 404 is configured of the same material as the main body portion 402 and the like, and is closed off.

### <Configuration of the Ink Tank 30C>

The configuration of the ink tank 30C is basically the same as that of the ink tank 30Bk, except for the arrangement of the communication port and not being equipped with a configuration corresponding to the enlarged portion 404. Specifically, the ink tank 30C, which has a smaller capacity than the ink tank 30Bk, has the main body portion 502 formed with the width W2 which is smaller than the width W1 in the X direction (see FIG. 5A). The main body portion 502 is equipped with the storage chamber 506 for storing ink. Note that, differing from the ink tank 30Bk, a configuration corresponding to the enlarged portion 404 is not installed in the ink tank 30C, and the ink tank 30C is formed smaller than the ink tank 30Bk in the X direction. Therefore, the amount of ink that can be stored in the storage chamber 506 is less than the amount of ink that can be stored in the storage chamber 406.

The main body portion 502 is equipped with the buffer portion 508 formed on the upper front side of the storage chamber 506 to serve as an atmospheric communication flow path, and the inlet path 510 that allows ink injected from the injection port 302 to flow into the storage chamber 506 (see FIG. 5B). Further, the main body portion 502 is equipped with the connecting path 512 that connects the storage chamber 506 to the joint portion 304. The opening portion 512a is formed at one end of the connecting path 512, which extends to near the bottom surface of the storage chamber 506, whereas the other end of the connecting path 512 is connected to the joint portion 304. Ink stored in the storage chamber 506 is transferred from the opening portion 512a to the joint portion 304 via the connecting path 512. The opening portion 512a is located on the front side of the storage chamber 506, and the bottom surface of the storage chamber 506 is shaped to slope gently downward from the back side to the front side. Further, the main body portion 502 is equipped with the insertion portions 514 through which the detection pins 604 can be inserted on the upper back side of the storage chamber 506, and the fixing member 516 that can fix the substrate 300.

The buffer portion 508 is equipped with five buffer chambers. Specifically, the buffer portion 508 is equipped with the first buffer chamber 520 positioned on the lower back side of the buffer portion 508, the second buffer chamber 522 positioned on the lower front side of the buffer portion 508, and the third buffer chamber 524 positioned on the upper side of the first buffer chamber 520. Further, the buffer portion 508 is equipped with the fourth buffer chamber 526 positioned on the upper back side of the second buffer chamber 522, and the fifth buffer chamber 528 positioned on the upper front side of the second buffer chamber 522.

The storage chamber 506 communicates with the first buffer chamber 520 via the opening 532. The opening 532 is positioned on the upper surface of the storage chamber 506 and is positioned at the approximate center of the storage chamber 506 in the Y direction. The first buffer chamber 520 communicates with the second buffer chamber 522 via the flow path 536, the second buffer chamber 522 communicates with the third buffer chamber 524 via the flow path 538, and the third buffer chamber 524 communicates with the fourth buffer chamber 526 via the flow path 540. Further, the fourth buffer chamber 526 communicates with the fifth buffer chamber 528 via the flow path 542, and the fifth buffer chamber 528 communicates with the outside of the ink tank 30C via the atmospheric communication port 544.

In this way, the storage chamber 506 is configured to communicate with the outside via the first buffer chamber 520, the second buffer chamber 522, the third buffer chamber 524, the fourth buffer chamber 526, and the fifth buffer chamber 528. Further, the first buffer chamber 520 opens in the +X direction, and the flow path 536 is configured to open in a different direction than the first buffer chamber 520 (that is, in the −X direction). Similarly, the second buffer chamber 522, the third buffer chamber 524, and the fourth buffer chamber 526 open in the −X direction, and the flow path 538, the flow path 540, and the flow path 542 open in the +X direction. Because the buffer chambers and the flow paths that communicate with the buffer chambers open in different directions, the configuration is such that it is difficult for the ink stored in the storage chamber 506 to leak out to the outside via the atmospheric communication port 544, no matter what the posture of the ink tank 30C is. Note that, on the left and right side surfaces of the ink tank 30C, a film (not illustrated in the drawings) is welded to each side of the main body portion 502, which seals the storage chamber 506, each buffer chamber in the buffer portion 508, the inlet path 510, the connecting path 512, and the flow paths communicating with each buffer chamber.

### <Configuration of the Ink Tank Unit 28>

In the ink tank unit 28, the ink tank 30C, the ink tank 30M, and the ink tank 30Y are installed side by side in the X direction along with the ink tank 30Bk. At this time, the ink tanks 30C, 30M, and 30Y, which have the same configuration, are arranged aligned with respect to the Y direction. On the other hand, the ink tank 30Bk is formed with only the enlarged portion 404 larger in the Y direction. Therefore, in the ink tank unit 28, the ink tanks 30C, 30M, 30Y, and the main body portion 402 of the ink tank 30Bk are arranged with their positions aligned with respect to the Y direction. Further, the enlarged portion 404 of the ink tank 30Bk is arranged in a position that overlaps with at least one of the ink tanks 30C, 30M, and 30Y in the X direction. In other words, the enlarged portion 404 overlaps with at least one of the ink tanks 30C, 30M, and 30Y as viewed from the Y direction. Furthermore, the enlarged portion 404 is positioned adjacent to the back sides of the overlapped ink tanks as viewed from the front side of the printing apparatus 10 (see FIG. 3A).

In the present embodiment, the enlarged portion 404 is configured to overlap with at least one of the ink tanks 30C, 30M, and 30Y. Therefore, the number of overlapped ink tanks and the amount of overlap in the X direction can be adjusted by changing the size and shape of the enlarged portion 404. Further, for example, in a case where the enlarged portion 404 overlaps with the ink tank 30C as viewed from the Y direction, it is sufficient for the enlarged portion 404 to overlap with at least a portion of the ink tank 30C. Similarly, in a case where the enlarged portion 404 overlaps with the ink tanks 30C, 30M, and 30Y, it is sufficient for the enlarged portion 404 to overlap with at least a portion of the ink tank 30C, the ink tank 30M, and the ink tank 30Y as viewed from the Y direction.

In this way, such an enlarged portion is installed for an ink tank whose capacity is desired to be increased, and this enlarged portion is formed so as to overlap in the X direction with the other ink tanks that are installed side by side in the X direction, thereby making it possible to suppress an increase in size in the X direction of the ink tank whose capacity is to be increased. In the present embodiment, the size (W1) of the main body portion 402 of the ink tank 30Bk in the X direction is larger than the size (W2) of the main body portion 502 of the ink tank 30C in the X direction. For example, by designing the enlarged portion 404 larger in this ink tank 30Bk, the size of the ink tank 30Bk in the X direction can be made to match W2 while maintaining the capacity of the ink tank 30Bk. This allows the size of the ink tank unit 28 in the X direction to be downsized, and the size of the accommodation portion 11, which is the space that accommodates the ink tank unit 28, can be reduced in the X direction.

In the present embodiment, for example, the capacity of the ink tank 30Bk is about 70 ml, and the capacity of the ink tanks 30C, 30M, and 30Y is about 40 ml. Note that the ratio of the Bk ink used in business documents is high. For this reason, in the printing apparatus 10, the ink tank 30Bk, which stores the Bk ink, is formed with a larger capacity than the ink tanks that store the other chromatic color inks.

### <Configuration of the Small Chamber>

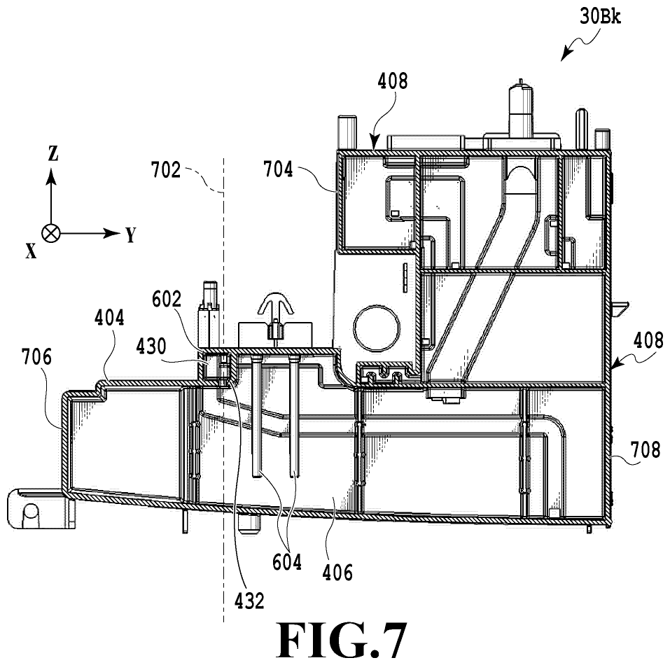

Next, an explanation is given of the configuration of the small chamber 430 installed in the ink tank 30Bk. FIG. 6A and FIG. 6B are enlarged views of the vicinity of the small chamber 430 of the ink tank 30Bk. FIG. 6A is a perspective view, and FIG. 6B is a view from the A arrow of the vicinity of the small chamber 430 in FIG. 6A. FIG. 7 is a left side view of the ink tank 30Bk.

The small chamber 430 installed between the storage chamber 406 and the buffer portion 408 is formed to allow the ink stored in the storage chamber 406 to flow in in a case where the ink tank 30Bk is in a different posture from that of the posture during use, even without air expansion or the like inside the storage chamber 406. The posture during use is, for example, the posture as the ink tank unit 28 is accommodated in the accommodation portion 11 of the printing apparatus 10 placed on a horizontal surface (see FIG. 3A). Further, in the explanation given below, a “different posture from the posture during use” is appropriately referred to as an “abnormal posture.”

Specifically, in the small chamber 430, the opening 432 is shaped as a slit extending in the X direction and is large enough that the ink stored in the storage chamber 406 does not form a meniscus (see FIG. 6A). As a result, if the ink tank 30Bk assumes an abnormal posture and the opening 432 is below the liquid surface of the ink, a gas-liquid exchange occurs at the opening 432, and the small chamber 430 is filled with ink. Thus, in the present embodiment, the small chamber 430 functions as an inflow chamber into which ink from the storage chamber 406 can flow.

Further, the communication port 602 that communicates with the flow path 434 is formed in the small chamber 430, and the small chamber 430 communicates with the first buffer chamber 420 of the buffer portion 408 via the communication port 602 and the flow path 434 (see FIG. 6B). The size, or in other words, the opening size of the communication port 602 is a size which allows the ink stored in the storage chamber 406 to form a meniscus at the communication port 602. The size of the communication port 602 is, for example, 1.6 mm in the Y direction and 2.0 mm in the Z direction.

Thus, due to the ink forming a meniscus at the communication port 602 of the small chamber 430, ink does not flow from the communication port 602 into the flow path 434 and does not flow out to the first buffer chamber 420 if ink simply flows into the small chamber 430. On the other hand, if a pressure change occurs inside the storage chamber 406, such as the expansion of air inside the storage chamber 406 while the ink in the small chamber 430 is forming a meniscus at the communication port 602, the meniscus is broken and the ink flows out of the communication port 602 into the first buffer chamber 420 via the flow path 434. Thus, in the ink tank 30Bk, the buffer portion 408 is configured to be able to accommodate the ink that cannot be held in the storage chamber 406 due to the expansion of air inside the storage chamber 406, or the like, in a case where the ink tank 30Bk is in an abnormal posture. In other words, in the present embodiment, the buffer portion 408 functions as an accommodation chamber that can accommodate the liquid that has flowed out of the storage chamber 406.

The communication port 602 is designed to be positioned at the center of the inner volume of the storage chamber 406 in the Y direction. This reduces the difference in the amount of the ink flowing into the communication port 602 due to tilting, even if the air inside the storage chamber 406 expands at the time where, for example, the front side of the ink tank 30Bk is in a posture tilted downward or the back side of the ink tank 30Bk is in a posture tilted downward. Note that the center of the inner volume is the position of the hypothetical line 702 (see FIG. 7) passing through the communication port 602, where the storage chamber 406 is divided in the Y direction such that the inner volume on one side is equal to the inner volume on the other side. Note that, for example, the opening 432 is also formed at a position that approximately matches the communication port 602 in the Y direction.

The opening 532 of the ink tank 30C is similarly designed to be positioned at the center of the inner volume of the storage chamber 506 in the Y direction (see FIG. 5A). Note that, in the ink tank 30Bk, since the enlarged portion 404 is installed on the back side, the center of the inner volume is positioned further to the back side by the inner volume of the enlarged portion 404. As a result, in the ink tank 30Bk, with respect to the Y direction, the communication port 602 and the opening 432 are positioned between the wall 704 on the back side of the buffer portion 408 and the wall 706 on the back side of the enlarged portion 404. On the other hand, in the ink tank 30C, since no enlarged portion is installed, the center of the inner volume of the storage chamber 506 is positioned at or in the vicinity of the center position of the storage chamber 506 with respect to the Y direction. That is, in the ink tank 30C, the opening 532 is positioned in front of the back side surface of the buffer portion 508.

### <Detection Pins>

Next, an explanation is given of the detection pins 604 (see FIG. 6A) capable of detecting if the liquid stored in the storage chamber 406 becomes a predetermined amount or less.

In the ink tank 30Bk, a pair of the detection pins 604 is inserted through the insertion portion 414, and the detection pins 604 are positioned inside the storage chamber 406. Further, in the ink tank 30C, the detection pins 604 are inserted through the insertion portions 514, and the detection pins 604 are positioned inside the storage chamber 506. Detection using the detection pins 604 is performed by electrification between the pairs of detection pins 604. As electrification happens via the ink if both of the detection pins 604 are immersed in ink, it is possible to detect that more ink than the predetermined amount is stored inside the storage chamber 406. On the other hand, if the detection pins 604 are exposed out of the ink, electrification does not happen as only air exists between the two detection pins 604, and thus it is possible to detect that the ink in the storage chamber 406 has become less than the predetermined amount.

For example, in the ink tank 30Bk, the closer the detection pins 604 are to the center of the storage chamber 406, the position the detection pins 604 are arranged in the Y direction is less affected by the posture of the ink tank 30Bk. The herein-described center of the storage chamber 406 is the position between the wall 708 on the front side of the main body portion 402 and the wall 706. If the detection pins 604 are positioned near the wall 706, the position of the liquid surface of the ink near the detection pins 604 in the Z direction will be significantly different in a case where the ink tank 30Bk is tilted to the front side, compared with a case where the ink tank 30Bk is tilted to the back side. For this reason, it is preferable to place the detection pins 604 at or near the center of the storage chamber 406, where the change in position of the liquid surface of the ink in the Z direction is small even during an abnormal posture. In the present embodiment, in the ink tank 30Bk, the wall 706, the communication port 602, the detection pins 604, the wall 704, and wall 708 are positioned in this order in the +Y direction.

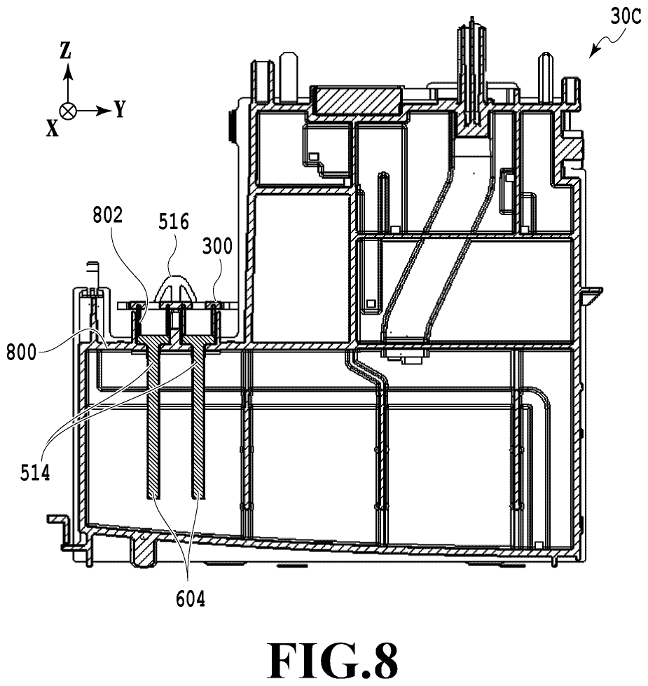

Note that the detection pins 604 are electrically connected to the circuit installed on the substrate 300 due to the compression spring 802 (see FIG. 8) made from metal or another conductive material. The substrate 300 is connected to the power supply by a cable from a connector. Voltage is applied to the detection pins 604 from this power supply, and it is determined by the control portion 200 whether there is or is not electrification, or in other words, whether or not the ink in the storage chamber is the predetermined amount or less, based on the resistance value between the two detection pins 604.

In the present embodiment, the two detection pins are used as the detection pin for detecting the remaining amount of the liquid, but there is no limitation as such. For example, multiple detection pins with different lengths in the Z direction may be used, so that the remaining amount of the liquid is detected by combinations of two of the multiple detection pins where no electrification happens.

### <Fixing Member>

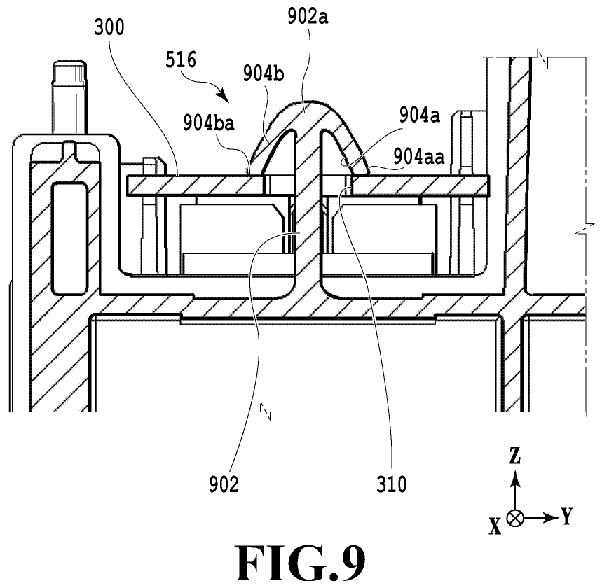

Next, an explanation is given about the configurations of the fixing members 416 and 516 for fixing the substrate 300. FIG. 8 is a cross-sectional view taken along the line VIII-VIII in FIG. 3A. FIG. 9 is an enlarged view of the vicinity of the fixing member in FIG. 8.

The fixing member 416 and the fixing member 516 installed in the respective ink tanks 30 are the configuration for fixing to the respective ink tanks 30 the substrate 300, on which a circuit and the like are formed to output a signal from the detection pins 604 installed in the respective ink tanks 30 to the control portion 200. Note that, since both the fixing member 416 and the fixing member 516 have the same configuration, in the following explanation, an explanation is given about the fixing member 516 and an explanation of the fixing member 416 is omitted.

The fixing member 516 extends in the ink tank 30C perpendicular to the plane 800 in which the insertion portions 514, through which the detection pins 604 are inserted, is formed. In the present embodiment, the fixing member 516 extends parallel to the Z direction. The fixing member 516 is positioned between the two detection pins 604 with respect to the Y direction (see FIG. 8). The fixing member 516 is equipped with the axial portion 902 extending in the Z direction and the regulating portion 904 at the tip of the axial portion 902 that regulates the removal of the inserted substrate 300 (see FIG. 9).

Note that the substrate 300, while being fixed by the fixing member 516, is electrically connected to the detection pins 604 via the compression spring 802. As a result, in a case where the substrate 300 is fixed to the fixing member 516, the substrate 300 is continually biased in a predetermined direction (the upper side in the present embodiment) by the compression spring 802. Therefore, the regulating portion 904 can be inserted into the hole portion 310 (see FIG. 3A and FIG. 9) installed in the substrate 300 for the insertion of the fixing member 516, and the regulating portion 904 is configured so that movement in the upward direction of the substrate 300 caused by the biasing force of the compression spring 802 after insertion can be regulated.

Specifically, the regulating portion 904 is formed in an arrowhead shape and is formed to gradually widen in the Y direction from the tip 902a of the axial portion 902 toward the lower side. In more detail, the regulating portion 904 is equipped with the returning portion 904a extending to the lower front side from the tip 902a of the axial portion 902 and the returning portion 904b extending to the lower back side. The returning portions 904a and 904b are connected to the axial portion 902 only at the tip 902a. Therefore, the returning portions 904a and 904b flex toward the axial portion 902 side, that is, toward the center of the fixing member 516, by pressure from the upper side to the lower side (the opposite direction of the direction of biasing by the compression spring 802), and the flexion is resolved once the pressure is released. Further, the returning portions 904a and 904b flex in the direction away from the axial portion 902, that is, in the direction away from the center of the fixing member 516, due to pressure from the lower side to the upward side.

For fixing the substrate 300 to the fixing member 516, the fixing member 516 is inserted into the hole portion 310 from the upper side. At this time, the returning portions 904a and 904b of the regulating portion 904 flex toward the axial portion 902 side due to the movement of the hole portion 310 toward the lower side, allowing the insertion into the hole portion 310, and at the timing where the hole portion 310 is positioned under the regulating portion 904, the flexion is resolved. In this case, the tip 904aa of the returning portion 904a becomes positioned outside of the hole portion 310, that is, on the front side of the circumference of the hole portion 310, and the tip 904ba of the returning portion 904b becomes positioned outside of the hole portion 310, that is, on the back side of the circumference of the hole portion 310. Although the substrate 300 is biased to the upper side by the compression spring 802, its movement to the upper side is regulated because the tips of the returning portions 904a and 904b are positioned outside of the hole portion 310. Thus, in the present embodiment, the fixing member 516 functions as a regulating member that regulates movement of the substrate 300 to the upper side due to the compression spring 802. Further, in the present embodiment, the fixing member 516 and the compression spring 802, which is a biasing member, work together to function as a fixing portion to fix the substrate 300.

By forming the fixing member 516 in this way, fixing the substrate 300 to the ink tank 30C becomes easy and also it becomes difficult for the substrate 300 to be removed from the ink tank 30C. Therefore, it is difficult for the substrate 300 to detach from the ink tank unit 28 to which the substrate 300 is fixed together with the fixing member 416, which has the same configuration as the fixing member 516. Further, since the fixing members 416 and 516 and the compression spring 802 work together to fix the substrate 300, displacement of the arrangement position of the substrate 300 due to vibration of the apparatus or the like is suppressed, and damage to the members is also reduced.

### Functional Effects

As explained above, in the present embodiment, an ink tank installed side by side together with multiple ink tanks in the X direction is equipped with a storage chamber formed to overlap with at least one of the other ink tanks as viewed from the Y direction. This makes it possible to suppress the ink tank unit becoming a large size in the X direction, where the ink tanks are installed side by side, and makes it possible to suppress an expansion of the space for accommodating the ink tank unit in the X direction. Further, by changing the shape of the enlarged portion, it becomes possible to change the inner volume ratio between the larger capacity ink tank and the other ink tanks, thereby increasing the degree of freedom in setting the ink capacity ratio between these two types of ink tanks.

Further, in the present embodiment, in the ink tank equipped with the above-described storage chamber, a small chamber is provided between the storage chamber and a buffer portion that is capable of accommodating ink that cannot be held in the storage chamber, which makes the ink flow easily in and out of the reservoir portion. Furthermore, in the small chamber, a communication port is installed that communicates with a flow path connected to the buffer portion, and the size of the opening of the communication port is designed to be a size which allows the ink to form a meniscus. This prevents the ink that has flowed into the small chamber from flowing into the buffer portion at the time where the ink tank is in an abnormal posture, and allows the ink to flow into the buffer chamber in a case where the air inside the storage chamber expands in a state where the ink has flowed into the small chamber. Further, the communication port is positioned at the center of the inner volume of the storage chamber. This makes it possible to suppress the amount of ink flowing into the communication port, even if the air in the storage chamber expands at the time where the ink tank is in an abnormal posture.

Moreover, in the present embodiment, a compression spring, which is arranged above the detection pins that detect the remaining amount of the ink in the storage chamber, biases the substrate on which the circuit is formed to the upper side, while the fixing member regulates movement of the substrate toward the upper side, thereby fixing the substrate to the ink tank. This makes it difficult for the substrate to detach from the ink tank, and also makes it difficult for the arrangement position of the substrate to be displaced due to vibrations generated in the apparatus, thereby reducing damage to the members.

### Other Embodiments

Note that the above-described embodiment may be modified as shown in the following (1) through (10).

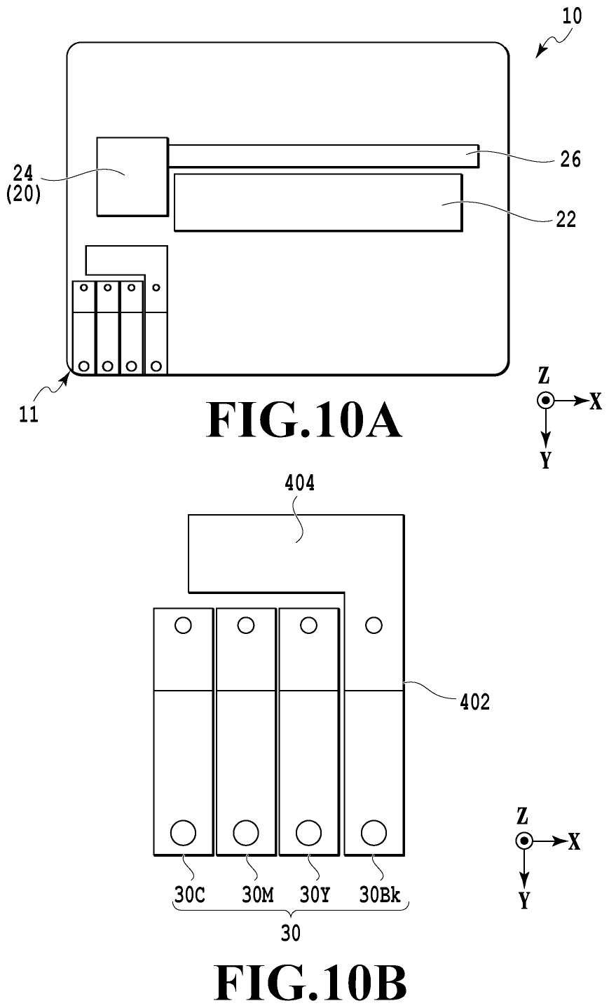

(1) In the above-described embodiment, the accommodation portion 11 is positioned on the front right side of the printing apparatus 10. Further, in the accommodation portion 11, the ink tank 30Bk, the ink tank 30C, the ink tank 30M, and the ink tank 30Y are arranged in this order in the +X direction. The position of the accommodation portion 11 in the printing apparatus 10 and the order of arrangement of each of the ink tanks in the accommodation portion 11 are not limited to this. For example, the accommodation portion 11 may be positioned on the front left side of the printing apparatus 10 (see FIG. 10A). Further, in this case, the ink tank 30C, the ink tank 30M, the ink tank 30Y, and the ink tank 30Bk may be arranged in this order in the +X direction (see FIG. 10B). Thus, in this case, the enlarged portion 404 of the ink tank Bk extends in the −X direction and overlaps with at least one of the ink tanks 30C, 30M, and 30Y as viewed from the Y direction. FIG. 10A and FIG. 10B are diagrams illustrating a modification example of the printing apparatus. FIG. 10A is a diagram illustrating a modification example of the arrangement position of the accommodation portion 11, and FIG. 10B is a diagram illustrating a modification example of the arrangement position of each of the ink tanks in the accommodation portion 11. Note that, in FIG. 10A and FIG. 10B, only the main configuration is illustrated in a simplified form for ease of understanding.

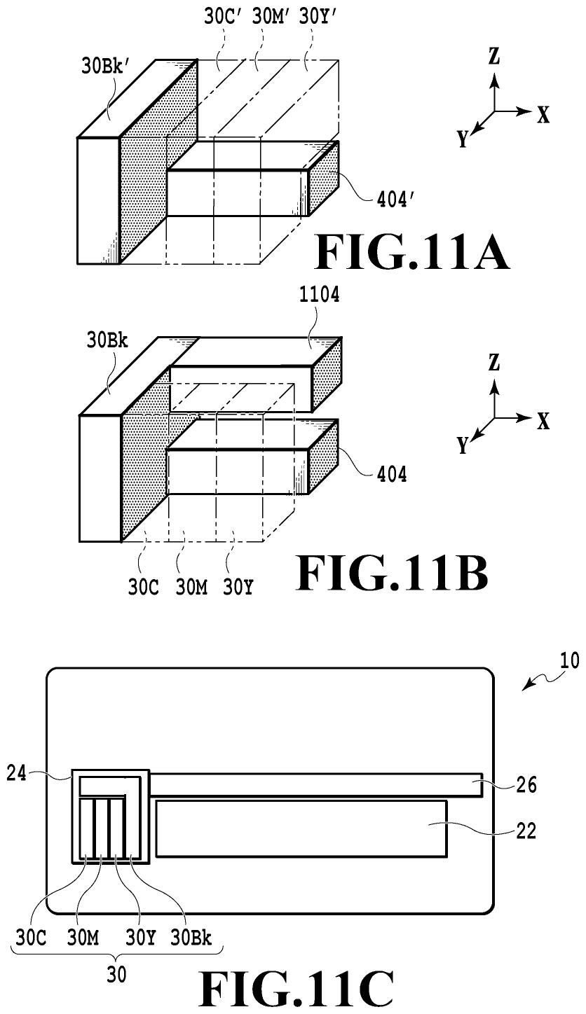

(2) In the above-described embodiment, the enlarged portion 404 of the ink tank 30Bk is configured to overlap with at least one of the ink tanks 30C, 30M, and 30Y as viewed from the Y direction, but there is no limitation as such. For example, as illustrated in FIG. 11A, the enlarged portion 404′ of the ink tank 30Bk′ may be configured to overlap with at least one of the ink tanks 30C′, 30M′, and 30Y′ in the X and Z directions. FIG. 11A is a diagram illustrating a modification example of the ink tank 30. Note that, in FIG. 11A, for ease of understanding, each configuration is illustrated in a simplified form, and the ink tanks 30C′, 30M′, and 30Y′ are illustrated with dashed lines.

(3) In the above-described embodiment, in the main body portion 402 of the ink tank 30Bk, the storage chamber 406 is formed together with the enlarged portion 404, which overlaps with the ink tanks 30C, 30M, 30Y, etc., in the X direction, but there is no limitation as such. For example, the enlarged portion 1104 that overlaps with at least one of the ink tanks 30C, 30M, 30Y in the X direction may be formed on the upper side of the enlarged portion 404, and the main body portion 402, together with the enlarged portion 1104, may be formed with the buffer portion 408 that serves as an atmospheric communication flow path (see FIG. 11B). FIG. 11B is a diagram illustrating a modification example of the ink tank 30Bk. Note that, in FIG. 11B, for ease of understanding, each configuration is illustrated in a simplified form, and the ink tanks 30C, 30M, and 30Y are illustrated with dashed lines.

(4) In the above-described embodiment, the accommodation portion 11 is installed in the printing apparatus 10 and the ink is supplied to the print head 20 from each of the ink tanks 30 of the ink tank unit 28 accommodated in the accommodation portion 11 via the tubes 34. For example, each of the ink tanks 30 may be mounted on the carriage 24, and each of the ink tanks 30 may be configured to be removable from the carriage 24 (see FIG. 11C). In this case, for example, each of the ink tanks 30 may be arranged in the +X direction in the order of the ink tank 30C, the ink tank 30M, the ink tank 30Y, and the ink tank 30Bk. FIG. 11C is a diagram illustrating a modification example of the printing apparatus 10. Note that, in FIG. 11C, each configuration is illustrated in a simplified form for ease of understanding.

(5) In the above-described embodiment, the two returning portions 904a and 904b are formed as the regulating portions 904 of the fixing members 416 and 516, but there is no limitation as such. For example, one or more than three of the returning portions may be formed. Further, in the above-described embodiment, one fixing member is provided for one ink tank 30, but there is no limitation as such, and multiple fixing members may be provided for one ink tank 30.

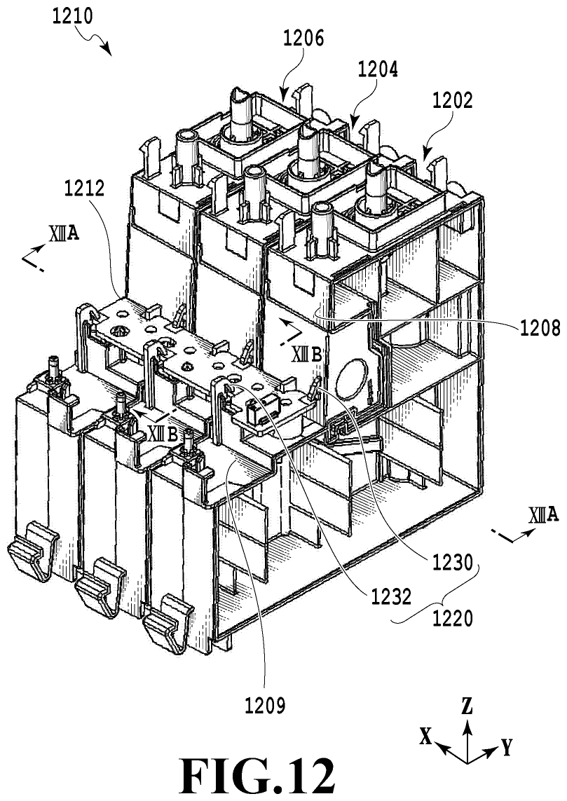

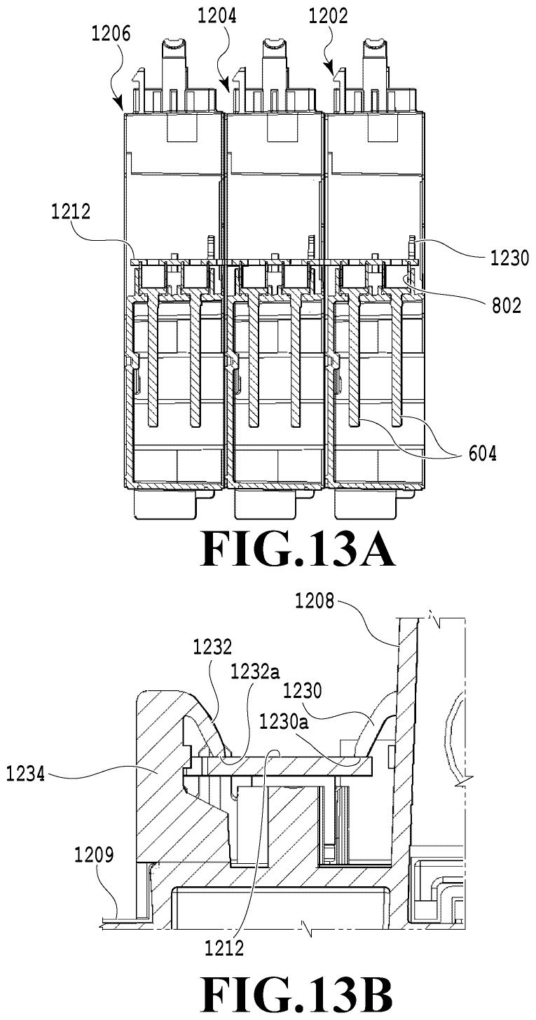

(6) In the above-described embodiment, the substrate 300 is fixed to the ink tank unit 28 by the fixing members 416 and 516 arranged between the two detection pins 604 in the Y direction, but there is no limitation as such. The mechanism for fixing the substrate 300 may be in the form of fixing using a claw portion, which fixes the long side of the substrate 300, in each of the ink tanks 30. Below, using FIG. 12 to FIG. 13B, a detailed explanation is given of a configuration equipped with the claw portions to fix the long side of the substrate 300. Note that, as the following explanation is an explanation of a modification example of the fixing mechanism, differing from the above-described embodiment, an explanation is given of an ink tank unit configured with ink tanks that are not equipped with the enlarged portion as an example. Note that, it is of course possible to apply the herein-described modification example of the fixing mechanism to an ink tank unit equipped with an ink tank that has an enlarged portion.

FIG. 12 is a diagram illustrating an example of the ink tank unit with the substrate fixed by another form of fixing mechanism. FIG. 13A is a cross-sectional view taken along the XIIIa-XIIIa line of FIG. 12, and FIG. 13B is a cross-sectional view taken along the XIIIb-XIIIb line of FIG. 12. In the ink tank unit 1210 equipped with the three ink tanks 1202, 1204, and 1206 formed with the claw portion 1220 that constitutes the other form of fixing mechanism, the substrate 1212 is fixed by the claw portion 1220 (see FIG. 12). In each of the ink tanks 1202, 1204, and 1206, the two detection pins 604 are installed side by side along the X direction (see FIG. 13A). Further, the detection pins 604 are electrically connected to the circuit formed on the substrate 1212 by the compression spring 802.

The claw portion 1220 is equipped with the first claw portion 1230 that abuts on the top surface of the front long side of the substrate 1212, which extends and is fixed in the X direction in the ink tank unit 1210. Further, the claw portion 1220 is equipped with the second claw portion 1232 that abuts on the top surface of the back long side of the substrate 1212. The first claw portion 1230 and the second claw portion 1232 are arranged, for example, at positions that do not overlap with each other in the X direction. In the present embodiment, the pair of detection pins 604 is positioned between the first claw portion 1230 and the second claw portion 1232 in the X direction.

The first claw portion 1230 is installed on the wall 1208 positioned on the back side of the buffer portion and extends to the lower back side from the wall 1208. The second claw portion 1232 extends to the lower front side from the tip of the erect portion 1234 erected on the plane 1209 which is parallel to the XY plane and is positioned on the back side of the wall 1208. The first claw portion 1230 flexes toward the wall 1208 due to pressure from the upper side to the lower side, and the second claw portion 1232 flexes toward the erect portion 1234 due to pressure from the upper side. Then, if these pressures are released, the flexions that occur in the first claw portion 1230 and the second claw portion 1232 are resolved. Further, the first claw portion 1230 flexes away from the wall 1208 due to pressure from the lower side to the upper side. Furthermore, the second claw portion 1232 flexes away from the erect portion 1234 due to pressure from the lower side.

For fixing the substrate 1212 to the claw portion 1220, the substrate 1212 is pressed from the upper side of the claw portion 1220. At this time, the first claw portion 1230 flexes toward the wall 1208 side and the second claw portion 1232 flexes toward the erect portion 1234 side, and the flexions are resolved at the timing where the substrate 1212 is positioned lower than the claw portion 1220.

Here, the interval in the Y direction between the wall 1208, which is a supporting member for the first claw portion 1230, and the erect portion 1234, which is a supporting member for the second claw portion 1232, is equal to or longer than the length of the substrate 1212 in the Y direction. Note that the length of the substrate 1212 in the Y direction is the length in the Y direction in the area where the substrate 1212 is fixed to each of the ink tanks by the claw portions 1220. Further, the interval in the Y direction between the tip 1230a of the first claw portion 1230 and the tip 1232a of the second claw portion 1232 is shorter than the length of the substrate 1212 in the Y direction.

This allows the tip 1230a of the first claw portion 1230 and the tip 1232a of the second claw portion 1232 to be positioned on the front surface of the substrate 1212 with the substrate 1212 in a state positioned lower than the claw portion 1220. At this time, the substrate 1212 is biased upward by the compression spring 802, but upward movement is regulated by the first claw portion 1230 and the second claw portion 1232.

Note that the claw portion 1220 may be configured so that one side of the two claw portions does not flex due to pressure from the up-down directions, while the other side flexes due to pressure from the up-down directions. Further, since it is sufficient that the substrate can be fixed to the ink tank unit, each of the ink tanks may be configured to be equipped with one claw portion. In this case, for example, adjacent ink tanks should have claw portions installed at different positions in the Y direction. In other words, in an ink tank unit such as that of FIG. 12, for example, the ink tanks 1202 and 1206 would only be equipped with the first claw portion 1230, and the ink tank 1204 would only be equipped with the second claw portion 1232.

(7) In the above-described embodiment, the fixing member 416 for fixing the substrate 300 is installed in each of the ink tanks of the ink tank unit 28, which is formed so that the particular ink tank among the four ink tanks 30 overlaps with at least part of the other ink tanks. The fixing member 416 is not limited to being formed only in this kind of ink tank unit 28, but may be formed in each ink tank of an ink tank unit configured with multiple ink tanks with the same shape as each other.

(8) In the above-described embodiment, the printing apparatus 10 is what is termed as a serial-scan type printing apparatus that performs printing by ejecting ink, while moving a print head in the X direction, onto a print medium conveyed in the Y direction, but there is no limitation as such. The printing apparatus to which the present invention can be applied may be, for example, what is termed a line-type printing apparatus that is equipped with a print head with a nozzle array formed in the X direction with a length corresponding to the width of the printable print medium, and that performs printing from the fixed print head onto the print medium conveyed in the Y direction.

(9) In the above-described embodiment, one ink tank is installed with the storage chamber formed larger due to the enlarged portion, but there is no limitation as such, and a plurality of such ink tanks may be installed. For example, in the ink tank 30Bk, the enlarged portion may extend in the +X direction to overlap with the ink tank 30C in the X direction, and in the ink tank 30Y, an enlarged portion may extend in the −X direction to overlap with the ink tank 30M in the X direction. Further, in the above-described embodiment, three ink tanks are installed without the enlarged portion 404 installed, but there is no limitation as such. There may be one, two, or even four or more ink tanks without the enlarged portion 404 installed.

(10) The above-described embodiment and various kinds of forms shown in (1) through (9) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-122180, filed Jul. 27, 2023, which is hereby incorporated by reference wherein in its entirety.

What is claimed is:

1. A printing apparatus comprising:
a conveyance unit configured to convey a print medium in a first direction;
a printing unit configured to perform printing by ejecting ink onto the print medium conveyed by the conveyance unit;
a first tank configured to store ink to be supplied to the printing unit; and
a second tank configured to be installed side by side with the first tank in a second direction intersecting the first direction, and to be formed so that a storage chamber that stores ink to be supplied to the printing unit overlaps with the first tank as viewed from the first direction,
wherein the storage chamber overlaps with the first tank as viewed from a third direction intersecting the first direction and the second direction.

2. The printing apparatus according to claim 1,
wherein, in an upper side of the storage chamber, the second tank is further provided with a second chamber configured to store ink flowed from the storage chamber.

3. The printing apparatus according to claim 2,
wherein the second chamber overlaps with the first tank as viewed from the first direction.

4. The printing apparatus according to claim 2,
wherein the second tank is further provided with an inflow chamber into which ink in the storage chamber flows, and
wherein the inflow chamber includes a communication port that flows the flowed-in ink to the second chamber in a case where a pressure change occurs.

5. The printing apparatus according to claim 4,
wherein the communication port has a size that allows ink stored in the storage chamber to form a meniscus.

6. The printing apparatus according to claim 4,
wherein the communication port is positioned at the center of the inner volume of the storage chamber in the first direction.

7. The printing apparatus according to claim 1,
wherein the second tank further includes
a detection unit configured to detect the amount of liquid in the storage chamber and
a fixing unit configured to fix a substrate connected electrically to the detection unit.

8. The printing apparatus according to claim 7,
wherein the fixing unit is provided with
a biasing member that biases the substrate in a predetermined direction and
a regulating member that regulates movement of the substrate toward the predetermined direction caused by the biasing member.

9. The printing apparatus according to claim 8,
wherein the biasing member is configured of conductive material and electrically connects the detection unit and the substrate.

10. The printing apparatus according to claim 7,
wherein the detection unit is arranged at or in the vicinity of the center of the storage chamber in the first direction.

11. The printing apparatus according to claim 8,
wherein the regulating member is provided with a returning portion that is formed widening toward the opposite direction of the predetermined direction,
wherein the returning portion flexes toward the center of the regulating member in a case of being inserted into a hole portion of the substrate moving in the opposite direction, thereby allowing the insertion into the hole portion and,
wherein, after the insertion into the hole portion, the returning portion flexes in a direction away from the center of the regulating member, thereby regulating movement of the substrate in the predetermined direction whereas the substrate is biased in the predetermined direction by the biasing member.

12. The printing apparatus according to claim 11,
wherein two of the returning portions are installed along the first direction.

13. The printing apparatus according to claim 8,
wherein the regulating member is provided with a claw portion supported by a supporting member and formed to extend away from the supporting member toward the opposite direction of the predetermined direction,
wherein the claw portion flexes toward the supporting member, thereby allowing the substrate to move in the opposite direction, and
wherein, after the movement, the claw portion flexes in a direction away from the supporting member, thereby regulating movement of the substrate in the predetermined direction whereas the substrate is biased in the predetermined direction by the biasing member.

14. The printing apparatus according to claim 13,
wherein the regulating member has a plurality of the claw portions installed at intervals spaced in the first direction.

15. The printing apparatus according to claim 14,
wherein the plurality of claw portions installed at the intervals spaced in the first direction is installed at positions differing from each other in the second direction.

16. The printing apparatus according to claim 1,
wherein the second tank is further provided with an injection port for injecting ink into the storage chamber.

17. The printing apparatus according to claim 16, further comprising
a moving unit configured to move the printing unit in the second direction,
wherein the first tank and the second tank are mounted to the moving unit.

18. A printing apparatus comprising:
a conveyance unit configured to convey a print medium in a first direction;
a printing unit configured to perform printing by ejecting ink onto the print medium conveyed by the conveyance unit;
a first tank configured to store ink to be supplied to the printing unit, and configured with an injection port for injecting ink internally; and
a second tank configured to be installed side by side with the first tank in a second direction intersecting the first direction, and to be formed so that a storage chamber that stores ink to be supplied to the printing unit overlaps with the first tank as viewed from a third direction intersecting the first direction and the second direction.

19. The printing apparatus according to claim 18,
wherein the second tank includes an injection port for injecting ink internally.
